(19) United States
(12) Patent Application Publication
(10) Pub. No.: US 2008/0243646 A1
(43) Pub. Date: Oct. 2, 2008

(54) Methods for proactively reconciling bin denials in inventory management environments

(76) Inventors: Andrew Christopher Stein, Morton, IL (US); Tammi Lyn Duncan, Pekin, IL (US)

Correspondence Address: CATERPILLAR/FINNEGAN, HENDERSON, L.L.P., 901 New York Avenue, NW, WASHINGTON, DC, 20001-4413, US

(21) Appl. No.: 11/731,630

(22) Filed: Mar. 30, 2007

(51) Int. Cl. G06Q 10/00

(52) U.S. Cl. 705/28

(57) ABSTRACT

A method for reconciling bin denials in inventory management environments comprises receiving a bin denial for a part number, the bin denial including data identifying a denied bin and a quantity associated with the bin denial. The method also includes determining a number of bins associated with the part number. The method further includes determining whether a quantity associated with the bin denial exceeds a predetermined threshold. An inventory count request for one or more bins associated with the part number is generated if the quantity associated with the bin denial exceeds the predetermined threshold.

### TECHNICAL FIELD

The present disclosure relates generally to inventory management processes and, more particularly, to systems and methods for proactively reconciling bin denials in inventory management environments.

### BACKGROUND

Inventory management plays an integral role in many of today's business environments, particularly those involving warehousing, storage, and maintenance of large quantities of materials for manufacture, sale, and/or distribution to a customer. In large warehouse environments, products may be stored in different locations, commonly referred to as “bins.” A particular product may be stored in one or more bins, and each bin may include a different quantity of the product. The quantity, part numbers, and bin location for each product may be stored in a computerized inventory database, which provides a centralized record of on-hand warehouse inventory.

For high-volume inventory items, bin quantities associated with these items may change fairly frequently, as customer orders are filled and bin supplies are replenished. For these high-volume items, proper inventory management is imperative, as small inventory errors, if not corrected, may lead to service loss (e.g., failure to timely fill a customer order). For instance, a pallet of stock for a particular item may be mistakenly placed in the wrong warehouse bin. If the inventory management system indicates that the parts are stocked in the correct bin and issues a part request from that bin to fill a customer order for the part, the correct bin may appear to be short by the misplaced quantity. In response, an inventory manager may either order replenishment stock to correct the apparent discrepancy, potentially leading to unnecessary expenditure of capital and storage resources necessary to store the additional material.

In an effort to minimize costs and reduce service losses associated with inventory management errors, some organizations rely on inventory verification processes to ensure that the inventory records accurately reflect the actual inventory stored in the bins. These verification processes may be performed periodically or in response to a service loss event, such as a failure to fill a customer order. One inventory verification process is described in U.S. Patent Publication No. 2004/0177013 (“the '013 publication) to Zhou. The '013 publication describes an audit process that compares physical inventory data and “book” (i.e., record) inventory data. If the physical inventory data matches the “book” inventory data, the “book” data is carried over to the next audit period. If, however, the physical inventory data does not match the “book” data, the discrepancy is “written off”, essentially forfeiting the difference between the physical inventory data and the “book” data as a loss.

While the audit process of the '013 publication may resolve discrepancies between physical inventory data and inventory record data in some situations, it may be costly and inefficient. For example, should a shipment of parts be accidentally misplaced in the wrong location and go undetected during an audit process, the entire shipment may be written off as a loss. Although write-offs may be useful in correcting minor inventory discrepancies that have gone unresolved for long periods of time, they may unnecessarily penalize minor errors that may not have been corrected in time for auditing. Furthermore, if, after write-off, the shipment is located and re-entered into the warehouse inventory, the resulting surplus may place a burden on existing inventory resources such as personnel (for re-stocking the parts) and warehouse storage space (for storing the extra parts).

In addition, periodic audit processes, such as the one discussed in the system of the '013 publication, typically require one or more manual recounts of the entire inventory in the warehouse. These manual recounts are time-intensive, expensive, and often require a temporary disruption in warehouse transactions until the count is complete. In order to eliminate the problems associated with periodic audits, some organizations perform inventory audit counts solely in response to a service loss event (e.g., inability to fulfill a customer order). While this may reduce the time, expense, and disruption associated with arbitrary, periodic audit counts, it may lead to decreased customer service and, ultimately, a loss of business.

The presently disclosed methods for proactively reconciling discrepancies in inventory management environments are directed toward overcoming one or more of the problems set forth above.

### SUMMARY OF THE INVENTION

In accordance with one aspect, the present disclosure is directed toward a method for reconciling bin denials in inventory management environments. The method may include receiving a bin denial for a part number, the bin denial including data identifying a denied bin and a quantity associated with the bin denial. The method may also include determining a number of bins associated with the part number. The method may further include determining whether a quantity associated with the bin denial exceeds a predetermined threshold. An inventory count request for one or more bins associated with the part number may be generated if the quantity associated with the bin denial exceeds the predetermined threshold.

According to another aspect, the present disclosure is directed toward a method for removing aged stock removal blocks in inventory management environments. The method comprises establishing a predetermined expiration associated with stock removal blocks and applying a stock removal block to a bin in response to a bin denial. The stock removal block may be configured to limit future part requests from the denied bin. The method may also include monitoring an age of the stock removal block and initiating an inventory reconciliation process if the age of the stock removal block exceeds a predetermined age threshold. In response to the initiation of the inventory reconciliation process, the stock removal block may be cleared.

In accordance with yet another aspect, the present disclosure is directed toward a system for reconciling bin denials in inventory management environments. The system comprises a processor, an input device communicatively coupled to the processor and configured to receive data associated with inventory management for a supply chain, and an output device communicatively coupled to the processor and configured to output data from the processor. The processor may be configured to receive a bin denial for a part number, the bin denial including data identifying a denied bin and a quantity associated with the bin denial. The processor may also be configured to determine a number of bins associated with the part number. The processor may be further configured to determine whether a quantity associated with the bin denial exceeds a predetermined threshold. An inventory count request for one or more bins associated with the part number may be generated if the quantity associated with the bin denial exceeds the predetermined threshold.

### BRIEF DESCRIPTION OF THE DRAWINGS

FIG. 1 provides a block diagram depicting an exemplary inventory management environment, consistent with the disclosed embodiments;

FIG. 2 provides a flowchart illustrating an exemplary process for responding to a bin denial for a part number associated with an inventory warehouse; and

FIG. 3 provides a flowchart illustrating an exemplary process for removing an aged stock removal block created in response to a bin denial associated with an inventory warehouse.

### DETAILED DESCRIPTION

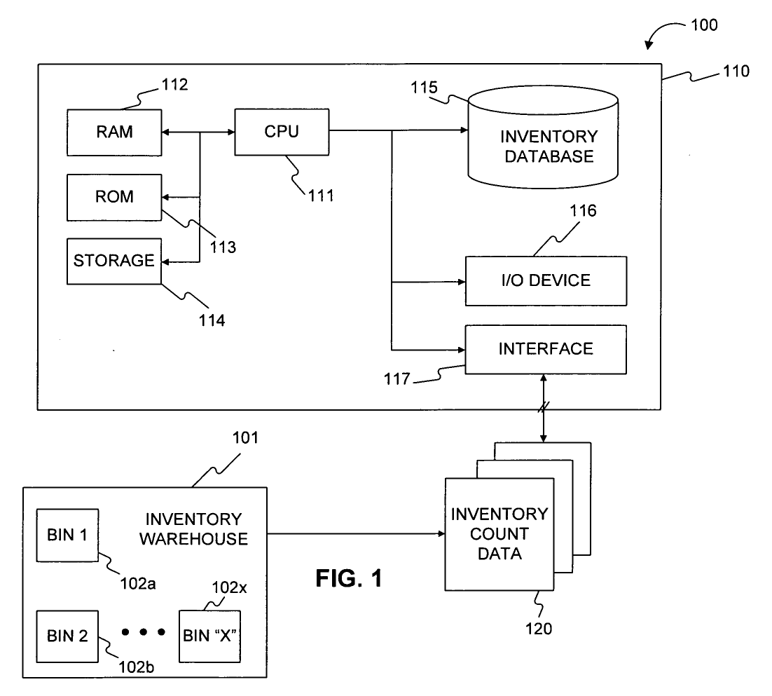

FIG. 1 provides a block diagram illustrating an exemplary disclosed inventory management environment 100. Inventory management environment 100 may be any type of supply chain environment associated with tracking, distributing, and/or managing inventory of a plurality of products. For example, inventory management environment 100 may include a product facility that manufactures, packages, ships, and monitors the sale and distribution of retail goods to consumers. Alternatively, inventory management environment 100 may include an entire supply chain operation that includes a plurality of warehouses dedicated to the acquisition, storage, and distribution of goods for an equipment manufacturer or dealer. According to one embodiment, inventory management environment 100 may include an inventory warehouse 101 for storage and distribution of the assets of the inventory and an inventory management system 110 for maintaining records associated with these assets.

Inventory warehouse 101 may include any type of facility for storing a plurality of products. Products, as the term is used herein, may include any physical or virtual element that may be used in connection with the performance of a business task. Non-limiting examples of physical products may include machines or machine parts or accessories such as, for example, electronic hardware or software; implements; traction devices such as tires, tracks, etc.; transmissions; engine parts or accessories; fuel; or any other suitable type of physical product. Non-limiting examples of virtual products may include inventory data, product documentation, software structures, software programs, financial data or documents such as stock records, or any other type of virtual product. Inventory warehouse 101 may include, for example, a parts depot, a product showroom, a document storage facility, or any other type of facility suitable for storing physical and/or virtual products.

Each product associated with inventory warehouse 101 may be assigned a unique part identification number. The part identification number may aid in the tracking of each part through the supply chain. A part identification number may include, for example, a numeric, alphabetic, alphanumeric, or symbolic code that may be used to identify and track the part number within inventory warehouse 101. Part numbers may also be associated with RFID devices and/or coded indicia systems (e.g., barcodes, etc.) that may be compatible with electronic scan technology.

Inventory warehouse 101 may include, or be subdivided into, a plurality of bins 102a-102x. Bin, as the term is used herein, refers to any physical location where one or more parts are stored within inventory warehouse 101. In one example, a first bin 102a may embody a particular rack or shelf location where engine blocks are stored in the inventory warehouse 101. In another example, a second bin 102b may be associated with a particular footprint of inventory warehouse space where a one or more different parts may be located. It is contemplated that one part number may be located in several bins throughout inventory warehouse 101.

According to one embodiment, a first bin, 102a, may include a rack location for storing a select number of engine blocks and/or high-volume inventory items. A second bin, 102b, may be associated with a second location of inventory warehouse 101 where an additional supply of engine blocks (and other parts) may be stored. As the inventory grows, additional bins may be created within inventory warehouse 101 to accommodate the growth. It is contemplated that the number and type of bins associated with a particular inventory warehouse may differ depending upon the size of the warehouse and the number of parts located therein. Each bin may be located in a different area of the warehouse and may contain different types and quantities of parts. Moreover, for a particular inventory warehouse 101 the number of bins may change as parts are added to, removed from, or relocated within, warehouse 101.

Inventory management system 110 may be any type of processor-based system on which processes and methods consistent with the disclosed embodiments may be implemented. For example, inventory management system 110 may be a personal computer loaded with software for managing a supply chain inventory. As illustrated in FIG. 1, inventory management system 110 may include one or more hardware and/or software components configured to execute software programs, such as software for monitoring, managing, tracking, forecasting, and analyzing data associated with inventory management environment 100.

According to one embodiment, inventory management system 110 may include one or more hardware components such as, for example, a central processing unit (CPU) 111, a random access memory (RAM) module 112, a read-only memory (ROM) module 113, a storage module 114, an inventory database 115, one or more input/output (I/O) devices 116, and an interface 117. Alternatively and/or additionally, inventory management system 110 may include one or more software components such as, for example, a computer-readable medium including computer-executable instructions for performing methods consistent with certain disclosed embodiments. It is contemplated that one or more of the hardware components listed above may be implemented using software. For example, storage module 114 may include a software partition associated with one or more other hardware components of inventory management system 110. Inventory management system 110 may include additional, fewer, and/or different components than those listed above. It is understood that the components listed above are exemplary only and not intended to be limiting.

CPU 111 may include one or more processors, each configured to execute instructions and process data to perform one or more functions associated with inventory management system 110. As illustrated in FIG. 1, CPU 111 may be communicatively coupled to RAM 112, ROM 113, storage module 114, inventory database 115, I/O devices 116, and interface 117. CPU 111 may be configured to execute sequences of computer program instructions to perform various processes, which will be described in detail below. The computer program instructions may be loaded into RAM 112 for execution by CPU 111.

RAM 112 and ROM 113 may each include one or more devices for storing information associated with an operation of inventory management system 110 and/or CPU 111. For example, ROM 113 may include a memory device configured to access and store information associated with inventory management system 110, including information for identifying, initializing, and monitoring the operation of one or more components and subsystems of inventory management system 110. RAM 112 may include a memory device for storing data associated with one or more operations of CPU 111. For example, ROM 113 may load instructions into RAM 112 for execution by CPU 111. 100231 Storage module 114 may include any type of mass storage device configured to store information that CPU 111 may need to perform processes consistent with the disclosed embodiments. For example, storage module 114 may include one or more magnetic and/or optical disk devices, such as hard drives, CD-ROMs, DVD-ROMs, or any other type of mass media device.

Inventory database 115 may include one or more software and/or hardware components that cooperate to store, organize, sort, filter, and/or arrange data used by inventory management system 110 and/or CPU 111. For example, inventory database 115 may include inventory records associated with each part number stored in inventory warehouse 110. Inventory database 115 may include, among other things, records corresponding to quantities associated with each part number; bin locations 102a-x where each part number is located; order statistics; historical data; and/or demand data associated with one or more part numbers. CPU 111 may access the information stored in inventory database 115 for comparing inventory count data 120 with the inventory record data to determine whether an adjustment to the inventory record may be required. CPU 111 may also analyze current and previous inventory count records to identify trends in inventory count data. These trends may then be recorded and analyzed to adjust one or more aspects associated with an inventory control process, which may potentially reduce inventory management errors leading to product loss and/or inventory write-off. It is contemplated that inventory database 115 may store additional and/or different information than that listed above.

I/O devices 116 may include one or more components configured to communicate information with a user associated with inventory management system 110. For example, I/O devices may include a console with an integrated keyboard and mouse to allow a user to input parameters associated with inventory management system 110. I/O devices 116 may also include a display including a graphical user interface (GUI) for outputting information on a monitor. I/O devices 116 may also include peripheral devices such as, for example, a printer for printing information associated with inventory management system 110, a user-accessible disk drive (e.g., a USB port, a floppy, CD-ROM, or DVD-ROM drive, etc.) to allow a user to input data stored on a portable media device, a microphone, a speaker system, or any other suitable type of interface device.

Interface 117 may include one or more components configured to transmit and receive data via a communication network, such as the Internet, a local area network, a workstation peer-to-peer network, a direct link network, a wireless network, or any other suitable communication platform. For example, interface 117 may include one or more modulators, demodulators, multiplexers, demultiplexers, network communication devices, wireless devices, antennas, modems, and any other type of device (or combination of devices) configured to enable data communication via a communication network.

As illustrated in FIG. 1, inventory management system 110 may be configured as a standalone system, separated from and communicatively coupled with inventory warehouse 101. As such, inventory management system 110 may embody a centralized inventory server that monitors and records stock levels associated with a plurality of warehouses and bins associated therewith. Alternatively and/or additionally, inventory management system 110 may be a system dedicated to and integrated within inventory warehouse 101 for monitoring and recording stock levels associated with the warehouse in which it is employed. In certain embodiments, inventory management system 110 may be configured as a regional server, communicatively coupled to an inventory database associated with each of a plurality of inventory warehouses in geographic proximity with each other. Accordingly, inventory management system 110 may be adapted to monitor and record inventory stock levels associated with one or more inventory warehouses within inventory management environment 100.

Inventory management system 110 may be configured to receive customer orders and locate one or more bins associated with inventory warehouse 101 that, according to inventory records contained in inventory database 115, contain an appropriate quantity of part numbers to fill the customer order. A customer order may be received electronically (via the Internet) or may be manually entered by inventory management personnel. Inventory management system 110 may search inventory database 115 and identify each bin associated with the part number. Inventory management system 110 may select one or more bins from which a quantity of parts will be pulled to fill the customer order. Inventory management system 110 may create an internal order that indicates the quantity of parts to be pulled from each bin. Each of the one or more bins may be searched for the corresponding quantity of parts associated with the internal order. If a bin contains the quantity of parts indicated on the corresponding internal order, the parts are pulled and applied to the customer order.

If, however, the actual number of parts located in the bin is less than the quantity indicated on the internal order for that bin, inventory management system 110 may issue a bin denial. Bin denial, as the term is used herein, refers to any instance where the bin does not contain an appropriate quantity of a particular part number, indicating a discrepancy between the actual quantity of a particular part number located in the bin and the quantity reflected in the inventory record. If the discrepancy is large enough, a bin denial may cause inventory management system 110 to request an inventory count to reconcile the inventory record data with the inventory count data 120 associated with each bin location. Methods and processes performed by inventory management system 110 in response to a bin denial are described in greater detail below.

By way of example, inventory management system 110 may receive an order for a quantity of engine blocks from a customer. In response to the request, inventory management system 110 may identify one or more bins 102a-x that, according to inventory database 115, contain the appropriate quantity of engine blocks to fill the customer order. Inventory management system 10 may create an internal warehouse order that identifies the quantity of engine blocks that are to be pulled from each of bins 102a-x. If each bin contains the quantity of engine blocks specified by inventory management system 110, the engine blocks are retrieved and tagged for delivery to the customer. If, however, one or more of the bins contain less than the quantity of engine blocks specified by inventory database 115, a bin denial for the each of the non-conforming bins may be generated and entered into inventory management system 110.

Inventory management system 110 may also be configured apply a stock removal block to the denied bin in response to the detection of a bin denial. The stock removal block can include any type of notification that may be configured to prevent inventory management system 110 from including the quantity of parts associated with the denied bin with the quantity of available products for sale or distribution to a customer, until an physical inventory verification may be performed to reconcile the inventory record with the actual inventory data. By blocking denied bins and preventing subsequent stock removals therefrom, inventory management environment 110 may prevent an error associated with a bin denial from affecting other bins within the warehouse. The stock removal block may be lifted upon reconciliation of the inventory record based on actual quantity of parts located in the denied bin. Additionally, the stock removal block may be configured to expire after a predetermined time period. The quantity of products associated with the expired stock removal block may be stored for further processing. Methods and features associated with an aged stock removal process will be described in further detail below.

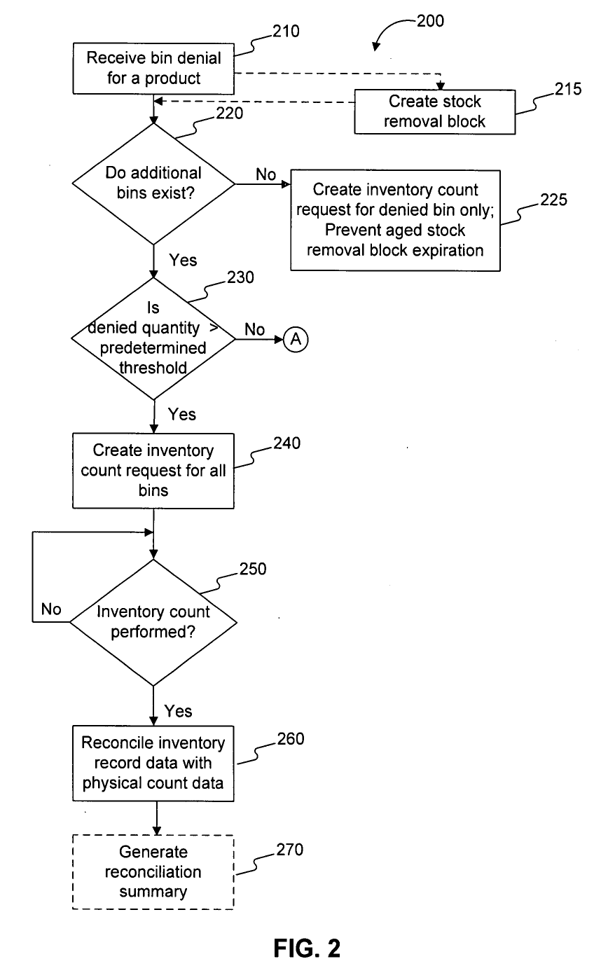

Processes and methods associated with disclosed embodiments provide an inventory record reconciliation solution that may enable organizations to more effectively maintain accurate inventory records, while minimizing the number of physical counts required to maintain the desired accuracy of the record. The presently disclosed inventory reconciliation process provides a proactive method for analyzing each bin denial associated with a part request and determining whether the quantity of parts associated with the bin denial is large enough to potentially trigger an inventory management problem. If the bin denial is relatively small, a stock removal block may be applied to the bin, which may also be tagged for reconciliation with a relatively low priority. On the other hand, if the bin denial is sizeable (i.e., greater than a predetermined denial threshold), inventory management system 110 may proactively prompt a physical inventory count to reconcile errors between the inventory record and the physical quantity. This method may limit physical counts that are performed in response to minor inventory record errors, while identifying and proactively reconciling inventory errors that may lead to service loss. FIG. 2 provides a flowchart 200 depicting an exemplary bin denial response process, in accordance with certain aspects of the disclosed embodiments.

The process may include receiving data corresponding to a bin denial of a product associated with a bin of inventory warehouse 101 (Step 210). The bin denial may be entered into inventory management system 110 manually by an inventory warehouse technician. Alternatively and/or additionally, inventory management system 110 may automatically receive data indicative of the number of parts in each bin (e.g., using RFID or other electronic tracking solutions). The bin denial data may include, among other things, a bin number identifying the denied bin, a part number identifying the part associated with the bin denial, and the quantity of parts denied by the bin. For instance, following the example above, inventory management system 110 may receive a customer order for 4 engine blocks and determine that, according to the inventory record, there are 5 engine blocks located in a first bin, 102a. If, however, there is only 1 engine block in first bin 102a, an inventory warehouse technician may enter a bin denial of 4 for the first bin (i.e., of the 5 originally shown in inventory only 1 was available, a deficiency of 4).

Upon receipt of a bin denial, inventory management system 110 may create a stock removal block and assign the stock removal block to the denied bin (Step 215). Following the example above, upon fulfillment of the customer order, a stock removal block may be applied to first bin 102a, thereby preventing inventory management system 110 from requesting any additional engine blocks from first bin 102a until the discrepancy associated with missing quantity of engine blocks is reconciled with the inventory record. By “freezing” the inventory associated with the denied bin, inventory management system 110 may prevent errors associated with one bin from affecting other bins as orders are being filled over the course of normal warehouse operations.

After the denial of a first bin, inventory management system 110 may search inventory database 115 to determine if there are any additional bins containing the requested part number (Step 220). If additional bins do not exist (Step 220: No), inventory management system 110 may request an inventory count of the denied bin (i.e., the denied bin) and prevent the stock removal block from expiring (Step 225). Following the example above, if first bin 102a is the only bin that, according to inventory database 115, contains engine blocks, inventory management system 110 may issue an inventory count request document, notifying inventory management personnel to perform a physical verification of the denied bin and the surrounding areas in an attempt to locate the missing parts.

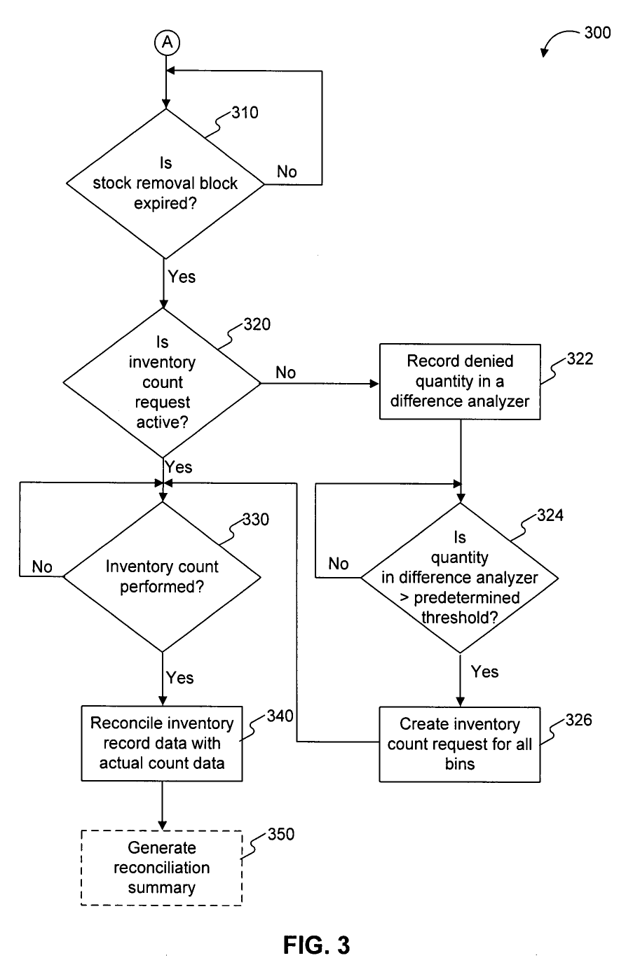

If, however, inventory management system 110 identifies additional bins containing the requested part number (Step 220: Yes), inventory management system 110 may compare the denied quantity with a predetermined denial threshold (Step 230). If the denied quantity does not exceed the predetermined denial threshold (Step 230: No), indicating that the quantity of parts associated with the bin denial has not reached a critical limit, the process may continue to Step “A” of FIG. 3. If, on the other hand, the denied quantity exceeds the predetermined denial threshold (Step 230: Yes), indicating that the bin denial has exceeded a critical limit, inventory management system may create an inventory count request for a plurality of bins that, according to inventory database 115, contain the requested part number (Step 240).

According to one embodiment, the predetermined threshold may include a percentage of the total quantity of the requested part number that is located within inventory warehouse 101. This percentage may be established by estimating or determining (based, for example, on historical data) an acceptable level of inventory error so as not to exceed a predetermined customer service loss level. Following the example above, the predetermined denial threshold may be established as 10% of the total quantity of engine blocks stocked in inventory warehouse 101. Accordingly, if the quantity associated with one or more bin denials exceeds 10% of the total inventory of engine blocks, inventory management system 110 may request an inventory count of all the bins that contain engine blocks in an effort to locate any missing engine blocks and/or correct any errors in the inventory record.

Once an inventory count request has been performed for each of the denied bins (Step 250: Yes), inventory management system 110 may reconcile inventory record data with physical count data 120 (Step 260). This reconciliation may include updating the inventory record for any quantity of denied material that was not located during the inventory count. If one or more of the parts associated with the bin denial are located, the inventory records may only be adjusted by any deficiency remaining after the lost parts are located. Following the example above, if 3 of the 4 missing engine blocks are later located during an inventory count, inventory management system 110 may adjust the stock record quantity of engine blocks associated with the denied bin corresponding to the 1 engine block that remains unaccounted for.

Once the inventory record has been reconciled based on the inventory count data 120, inventory management system 110 may clear the bin denial and remove the corresponding stock removal block from the denied bin. According to one embodiment, inventory management system 110 may generate a reconciliation report that summarizes any inventory adjustments performed on the inventory record (Step 270). These adjustments may be stored in memory (e.g., a “virtual” bin) for a predetermined period of time (e.g., 1 year) to allow for any misplaced, lost, or otherwise unaccounted for materials to be located during subsequent inventory count processes. If the inventory adjustments are not reconciled during the predetermined time period, these parts may ultimately be written-off as a loss. By keeping track of lost materials in a virtual bin, any missing parts may be excluded from the “official” inventory record, while allowing for their subsequent retrieval and re-entry into the inventory population.

FIG. 3 provides a flowchart 300 depicting an exemplary aged stock removal block process associated with the bin denial process shown in FIG. 2. Although FIG. 3 is illustrated as a process that stems from the bin denial process illustrated in FIG. 2, it is contemplated that the process may be implemented as a separate process, which may be periodically conducted independent of the bin denial process of FIG. 2. However, according to one embodiment and, as illustrated in FIGS. 2 and 3, it is contemplated that certain processes of the aged stock removal process may be performed whenever the denied quantity of parts associated with a bin denial does not exceed a predetermined denial threshold. These processes may be performed at predetermined intervals (e.g., hourly, daily, weekly, etc.) until the aged stock removal process is resolved.

As illustrated in FIG. 3, inventory management system 110 may monitor the age of a stock removal block to determine if the stock removal block has exceeded its expiration date (Step 310). According to one embodiment, the expiration date may include a user-defined expiration (e.g., 2 days, 1 week, 1 month, etc.). This user-defined expiration may be based on one or more factors including, for example, the amount of turnover for the part, the quantity of denied parts associated with the blocked bin, the severity of the bin denial leading to the stock removal block, or any other suitable user-defined criteria. For example, the aged stock removal block for low-inventory or low-demand items may have a longer duration than stock removal blocks for high-demand items. Those skilled in the art will recognize that blocks preventing removal of stock from high-inventory bins may more dramatically affect the overall customer service level, particularly if the blocked bin is associated with a large percentage of the inventory population for a particular part.

Once an expired stock removal block has been identified, inventory management system 110 may determine if an inventory count request is still active (Step 320), indicating that the inventory count has not yet been performed. For example, if the inventory count request is relatively recent, the inventory count request may not yet have been performed. If, however, the inventory count request is no longer active (e.g., the count has been performed) (Step 320: No), inventory management system 110 may record the denied quantity in a difference analyzer (not shown) (Step 322). The difference analyzer may include a particular memory location dedicated to storing bin denial quantities that were not large enough to provoke a system-wide recount. For example, if the quantity associated with a bin denial was relatively small (e.g., 1 or 2 units), which may not be large enough to provoke a recount of multiple bins for a particular product, these units may be recorded in a difference analyzer. Although these small bin denial quantities may not individually be large enough to provoke a system-wide recount of multiple bins associated with a particular part number, their compilation may, over time, reach a level significant enough to warrant correction and validation of the inventory. Difference analyzer may be configured to collect and tabulate multiple denied quantities that may occur over a period of time.

Inventory management system 110 may determine if the cumulative denied quantity recorded in the difference analyzer is greater than the predetermined denial threshold (Step 324). As explained, the predetermined denial threshold may include a percentage of the total inventory quantity of the particular part number that is stored in all of the bins in inventory warehouse 101. If the denied quantity is greater than the predetermined threshold (Step 324: Yes), inventory management system 110 may create an inventory count request for each bin associated with the part number of the bin denial (Step 326).

If the inventory management system 110 determines that the inventory count request is active (Step 320) (indicating that the inventory count request has not yet been performed) or if an inventory count request for all bins has been created in Step 326, inventory management system 110 may await the performance of the inventory count (Step 330: Yes). Once the inventory count has been performed, inventory management system 110 may reconcile inventory record data with actual count data 120 (Step 340). As explained, this reconciliation may include updating the inventory record for any quantity of denied material that was not located during the inventory count. If one or more of the parts associated with the bin denial are located, the inventory records may only be reconciled for any deficiency remaining after the lost parts are located. Following the engine block example above, if 3 of the 4 missing engine blocks are located during the inventory count, inventory management system 110 may adjust the stock record quantity of engine blocks associated with the denied bin to reflect that only 1 engine block remains unaccounted for.

Once the inventory record has been reconciled based on the inventory count data 120, inventory management system 110 may clear the bin denial and remove the corresponding stock removal block from the denied bin. According to one embodiment, inventory management system 110 may generate a reconciliation report that summarizes any inventory adjustments performed on the inventory record (Step 350). If the inventory adjustments are not reconciled during the predetermined time period, these parts may ultimately be written-off as a loss.

Although certain aspects of the exemplary method may be illustrated and/or described in connection with or being performed by inventory management system 110, it is contemplated that the method may alternatively be implemented or performed manually, without the use of inventory management system 110.

### INDUSTRIAL APPLICABILITY

Although the presently disclosed methods are described in connection with the management of inventory in product warehouse environments, they may be applicable to any environment where it may be advantageous to proactively reconcile differences between inventory records and actual inventory quantities. Specifically, the presently disclosed methods provide an inventory management solution that proactively determines, based on the size of a bin denial event, the scope of a physical inventory count that may be required to minimize the impact on customer service levels. As a result, costly physical inventory recounts may be postponed or consolidated until such time that the quantity associated with bin denials may reach a level that could potentially impact a customer service level.

The presently disclosed methods for reconciling bin denials in inventory management environments may have several advantages. First, the methods described herein may only require the selective performance of physical inventory counts, limiting the physical counts to only those bins associated with part numbers whose inventory error reaches a critical threshold level. In contrast, many conventional systems routinely perform full physical inventory counts for an entire inventory population once an inventory error is detected for a single part number. By limiting the scope of physical inventory counts to only those bins associated with problematic part numbers, the cost and disruption of inventory counts may be reduced when compared to conventional inventory management systems.

In addition, the presently disclosed methods include a feature that proactively performs physical inventory counts upon detection of a bin denial, prior to a customer service loss. As a result, the presently disclosed system may allow users to establish low denial threshold levels for expensive parts or parts that require long order lead-times prompting an inventory count process well in advance of any service loss to the customer. By allowing users to customize and modify the threshold that triggers a proactive inventory count and reconciliation shortly after detection of a bin denial, the presently disclosed methods may ensure that inventory errors are corrected prior to a loss in customer service.

It will be apparent to those skilled in the art that various modifications and variations can be made to the presently disclosed systems and methods for proactively reconciling bin denials in inventory management environments. Other embodiments of the present disclosure will be apparent to those skilled in the art from consideration of the specification and practice of the present disclosure. It is intended that the specification and examples be considered as exemplary only, with a true scope of the present disclosure being indicated by the following claims and their equivalents.

What is claimed is:

1. A method for reconciling bin denials in inventory management environments, comprising:
receiving a bin denial for a part number, the bin denial including data identifying a denied bin and a quantity associated with the bin denial;
determining a number of bins associated with the part number;
determining whether a quantity associated with the bin denial exceeds a predetermined threshold; and
generating an inventory count request for one or more bins associated with the part number if the quantity associated with the bin denial exceeds the predetermined threshold.

2. The method of claim 1, further including:
receiving inventory count data associated with an inventory count performed on the one or more bins; and
updating inventory record data associated with the one or more bins based on the inventory count data.

3. The method of claim 2, further including generating an inventory reconciliation summary associated with each of the one or more bins.

4. The method of claim 1, further including creating a stock removal block for the denied bin, the stock removal block configured to limit future part requests from the denied bin.

5. The method of claim 4, further including:
creating an inventory count request for the denied bin;
determining whether the inventory count request for the denied bin is active, in response to an expiration of the stock removal block;
receiving inventory count data associated with an inventory count performed on the denied bin if the inventory count request for the denied bin is active; and
updating inventory record data associated with the denied bin based on the inventory count data.

6. The method of claim 4, further including:
storing the quantity associated with the bin denial if the inventory count request for the denied bin is inactive, in response to an expiration of the stock removal block; and
generating an inventory count request for the one or more bins associated with the part number if a total quantity of part numbers associated with one or more bin denials exceeds the predetermined threshold.

7. The method of claim 6, further including:
receiving inventory count data associated with an inventory count performed on the one or more bins; and
updating inventory record data associated with the one or more bins based on the inventory count data.

8. The method of claim 1, wherein the predetermined threshold includes a percent of a total quantity of parts associated with a plurality of bins in an inventory warehouse.

9. The method of claim 1, wherein receiving a bin denial for a part number includes:
receiving a customer order that includes at least one part number;
identifying bins that include at least one of the part number;
requesting a quantity of the part number from one or more of the identified bins;
creating the bin denial for one or more bins if the quantity of the part number requested from a particular bin is inconsistent with an actual quantity of the part number in the one or more bins, wherein the bin denial includes data indicative of the difference between the requested quantity and the actual quantity.

10. A computer-readable medium for use on a computer system, the computer-readable medium including computer-executable instructions for performing the method of claim 1.

11. A method for removing aged stock removal blocks in inventory management environments, comprising:
applying a stock removal block to a bin in response to a bin denial, the stock removal block configured to limit future part requests from the denied bin;
monitoring an age of the stock removal block;
initiating an inventory reconciliation process if the age of the stock removal block exceeds a predetermined age threshold; and
clearing the stock removal block in response to the initiation of the inventory reconciliation process.

12. The method of claim 11, wherein the inventory reconciliation process includes determining whether an inventory count request for the denied bin is active.

13. The method of claim 12, further including:
storing a quantity of part numbers associated with the bin denial if the inventory count request for the denied bin is inactive;
generating an inventory count request for the plurality of bins associated with the part number if a total stored quantity of part numbers exceeds the predetermined threshold.

14. The method of claim 12, further including:
receiving inventory count data associated with an inventory count performed on the plurality of bins if the inventory count request for the denied bin is active; and
updating inventory record data associated with the plurality of bins based on the inventory count data.

15. The method of claim 14, further including generating an inventory reconciliation summary associated with each of the plurality of bins, wherein the inventory reconciliation summary includes data indicative of adjustments made to inventory record data based on the inventory count data.

16. The method of claim 11, wherein the predetermined threshold includes a percent of a total quantity of parts associated with a plurality of bins in an inventory warehouse.

17. A system for reconciling bin denials in inventory management environments comprising:
a processor;
an input device communicatively coupled to the processor and configured to receive data associated with inventory management for a supply chain; and
an output device communicatively coupled to the processor and configured to output data from the processor;
wherein the processor is configured to:
receive a bin denial for a part number, the bin denial including data identifying a denied bin and a quantity associated with the bin denial;
determine a number of bins associated with the part number;
determine whether a quantity associated with the bin denial exceeds a predetermined threshold; and
generate an inventory count request for one or more bins associated with the part number if the quantity associated with the bin denial exceeds the predetermined threshold.

18. The system of claim 17, wherein the processor is further configured to:
receive inventory count data associated with an inventory count performed on the plurality of bins;
update inventory record data associated with the one or more bins based on the inventory count data; and
generate an inventory reconciliation summary associated with each of the one or more bins.

19. The system of claim 17, wherein the processor is further configured to create a stock removal block for the denied bin, the stock removal block configured to limit future part requests from the denied bin.

20. The system of claim 17, wherein receiving a bin denial for a part number includes:
receiving a customer order that includes at least one part number;
identifying bins that include at least one of the part number;
requesting a quantity of the part number from one or more of the identified bins;
creating the bin denial for one or more bins if the quantity of the part number requested from a particular bin is inconsistent with an actual quantity of the part number in the one or more bins, wherein the bin denial includes data indicative of the difference between the requested quantity and the actual quantity.
